(19) United States
(12) Patent Application Publication
(10) Pub. No.: US 2005/0067389 A1
(43) Pub. Date: Mar. 31, 2005

(54) Target manipulation for pulsed laser deposition

(76) Inventors: James A. Greer, Andover, MA (US); Brendan Howard, Westford, MA (US); Michael Paradise, Windham, NH (US); Sergey N. Ivnitskiy, Beverly, MA (US); David Lations, Manchester, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/670,765

(22) Filed: Sep. 25, 2003

(51) Int. Cl. B23K 26/00

(52) U.S. Cl. 219/121.68; 427/596

(57) ABSTRACT

In a method and apparatus for pulsed laser deposition, a target is eroded more uniformly by employing a two-stage laser scanning process. In a first stage, a pulsed laser strikes the target along an x/y scan pattern across the surface of the target while the target is rotationally fixed. In a second stage, the target is rotated by an incremental angle. These two stages are continuously repeated in sequence throughout the pulsed laser deposition process.

### BACKGROUND

Pulsed laser deposition (PLD) of ceramic materials has been emerging over the past 15 years as a viable deposition technique of ceramic thin films. In PLD processes, laser pulses are directed against a target comprising the material to be deposited. The laser pulses each strike a small area on the surface of the target and vaporize part of the target at and near where the target is struck by the laser pulse. As the process has been scaled up to larger sizes, PLD targets have also grown in size; PLD systems now exist that utilize targets that have 6-inch or 10-inch diameters.

The ablated target material, in the form of a plume of vapor and entrained particulates, is deposited as a thin film on a substrate positioned above the target. As shown in FIG. 1a, the target 12 is often continuously rotated about an axis to change the position at which the incident laser beam 10 strikes the target 12 to produce the plume 14 for deposition on the substrate 16 throughout the process. However, this process will eventually lead to the formation of a circular trench 17 in the target after prolonged ablation, as shown in FIG. 1b.

Efforts to minimize morphology changes on the surface of the target have led to the additional step of sweeping the target 12 reciprocally over a linear or arc path as the target 12 is spinning, as shown in FIG. 2a. For comparison, the macroscopic profiles of (a) a new target and (b) a used target (after a period of ablation via the scanning method shown in FIG. 2a) are provided in FIGS. 2b and 2c. Further still, the microscopic profile of the target after ablation is provided in FIG. 2d, wherein the ridges are the cross-sections of microscopic cones eroded into the target surface. The ablated target surface is at the top of the profiles in FIGS. 2c and 2d.

In other embodiments, the laser beam 10 can be reciprocally displaced by a raster mirror 15 while the target is spinning, as shown in FIG. 2e. Nevertheless, the same microscopic cone structure will develop, as shown in FIG. 2d.

The microscopic changes to the surface profile of an eroded target 12 is shown in FIG. 3b. FIG. 3a shows the desired, directly outward projection of the plume 14 toward the substrate 16 from a new target 12. In FIG. 3b, the plume 14 is skewed back toward the laser beam 10 due to the cones in the microstructure, similar to those illustrated in FIG. 2d, wherein the target 16 is now at the edge of the plume 14 and coating of the target material onto the substrate 16 will be less intense and less uniform.

### SUMMARY

This disclosure describes a new approach to target motion that allows the laser beam to attack the target from a great variety of directions, thereby minimizing uneven microscopic target erosion. Thus, the plume will be emitted in a direction that is essentially normal to the target surface (i.e., the desired orientation for most useful applications).

Laser pulses are directed against a target in a scanning pattern that traverses the target, and the target is periodically rotated by an increment of rotation (e.g., 26.6°). The target will generally be rotated only after a full or nearly full cycle of the scanning pattern. The scanning pattern can be achieved either by moving the target in an x/y pattern or by directing the laser pulses in an x/y pattern. The x/y scanning pattern and rotation sequence can then be repeated over and over.

By continuously displacing and then rotating the target, every point on the target surface will be attacked by the laser at a wide range of angles. By repeatedly shifting the angle at which any given position is attacked by the laser, cone-formation is significantly reduced such that microscopic cones do not have any substantial affect on the angle at which the plumes leave the target surface.

The substantially even erosion of the target surface keeps the fluence (i.e., the energy density) on the target constant with time; in contrast, cone formation reduces fluence by spreading out the energy. A change in fluence also affects film properties, while constant fluence provides reproducible film properties and deposition rates. Moreover, the substantially uniform erosion of the target surface keeps the deposition rate constant on the substrate since the angle the plume makes with the target remains stable over a long period of time.

### BRIEF DESCRIPTION OF THE DRAWINGS

In the accompanying drawings, described below, like reference characters refer to the same or similar parts throughout the different views. The drawings are not necessarily to scale, emphasis instead being placed upon illustrating particular principles of the methods and apparatus characterized in the Detailed Description.

FIG. 1a illustrates the generation of a plume from a new target wherein the target is rotating.

FIG. 1b illustrates the generation of a plume from a used (eroded) target wherein the target is rotating.

FIG. 2a illustrates rotation and raster scanning of a target under a fixed incident laser beam.

FIG. 2b illustrates the section of a new target.

FIG. 2c illustrates the macroscopic changes on a section of a used (eroded) target.

FIG. 2d illustrates the microscopic morphological changes on the used target of FIG. 2c.

FIG. 2e illustrates a PLD system wherein the laser beam is displaceable with a raster mirror.

FIG. 3a illustrates the absence of tilt of a plume emitted from a new target.

FIG. 3b illustrates the tilt of a plume emitted from a target on which microscopic cones have formed.

FIG. 4 is a perspective view of a target manipulation apparatus.

FIG. 5 is a top view of the target manipulation apparatus of FIG. 4.

FIG. 6 is a perspective view of components of the target manipulation apparatus of FIGS. 4 and 5.

FIG. 7 is an image showing the laser scan path on the target in the x/y-stage of the two-stage target manipulation procedure.

FIG. 8 is an image showing the scan path of a laser on the target after many sequences of the sequential x/y scans and incremental target rotations.

FIG. 9 is a photograph of a target surface at an intermediate stage of the scanning process, wherein a full x/y scan was performed; the target was rotated; and another x/y scan was commenced. The path tracked by the laser across the surface appears lighter than the remainder of the target.

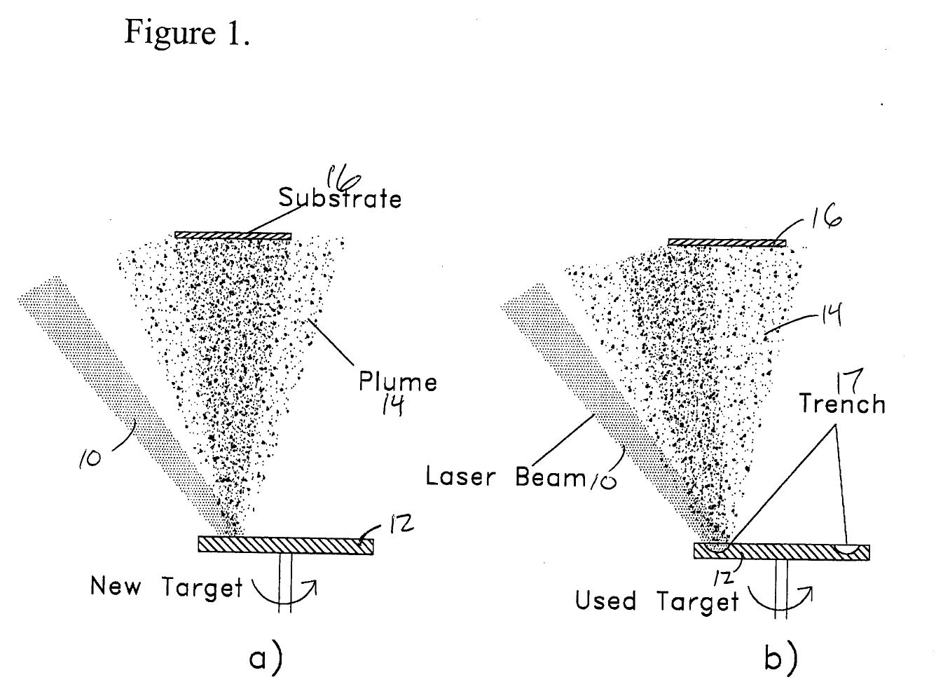

### DETAILED DESCRIPTION

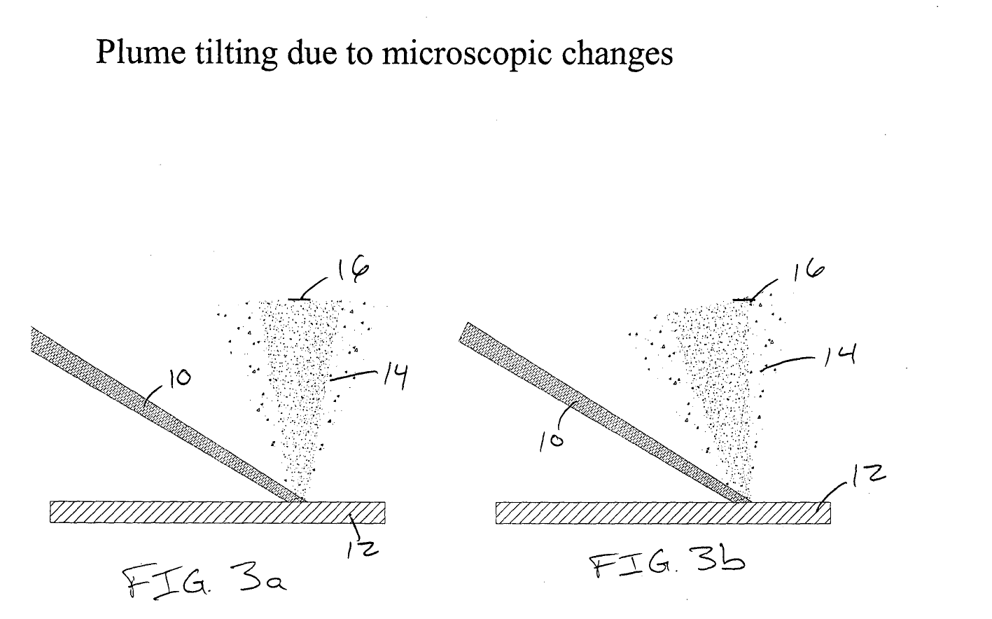

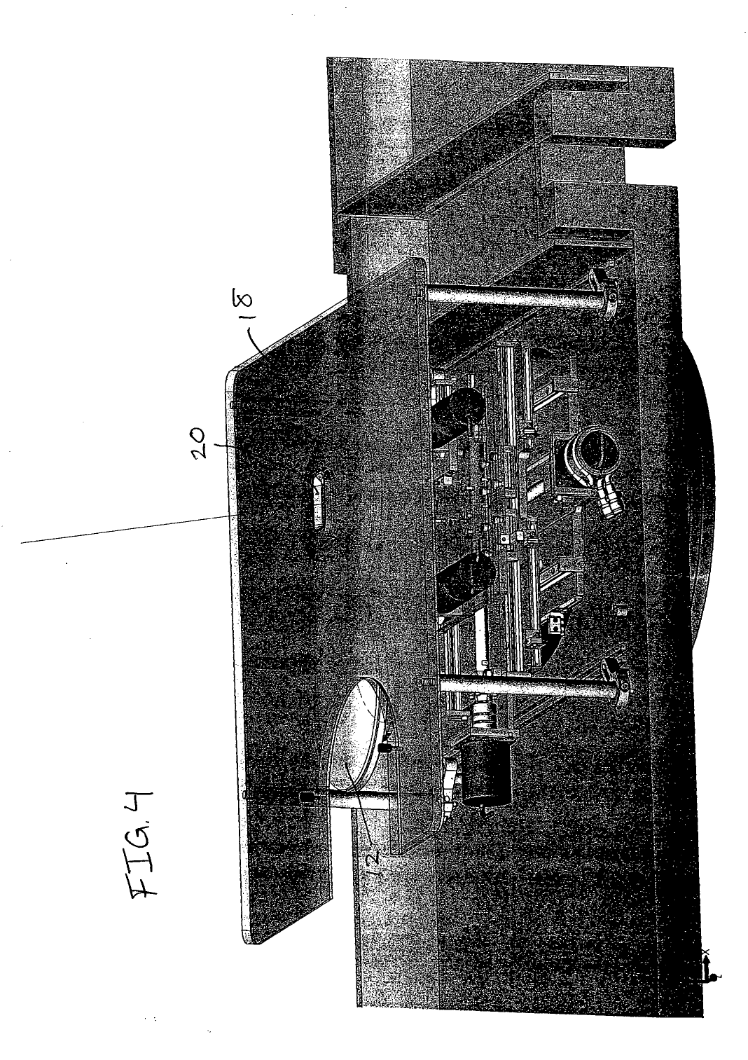

A perspective view of a target manipulation apparatus is provided in FIG. 4. A top water-cooled protective plate 18 is mounted above a pair of targets 12. An aperture 20 is defined in the protective plate 18 through which the laser can be directed and through which a plume can rise from the target for deposition on a substrate (not shown) positioned above the protective plate 18. A top view of this apparatus is provided in FIG. 5. The apparatus along with the substrate upon which the target material is deposited, is maintained in a vacuum chamber at a vacuum pressure of 0.5 to 300 mTorr. The substrate is heated with an infrared heat lamp or any other means to a temperature of 500 to 950° C., depending on the refractory properties of the particular substrate and is position between about 2 to about 6 inches from the target.

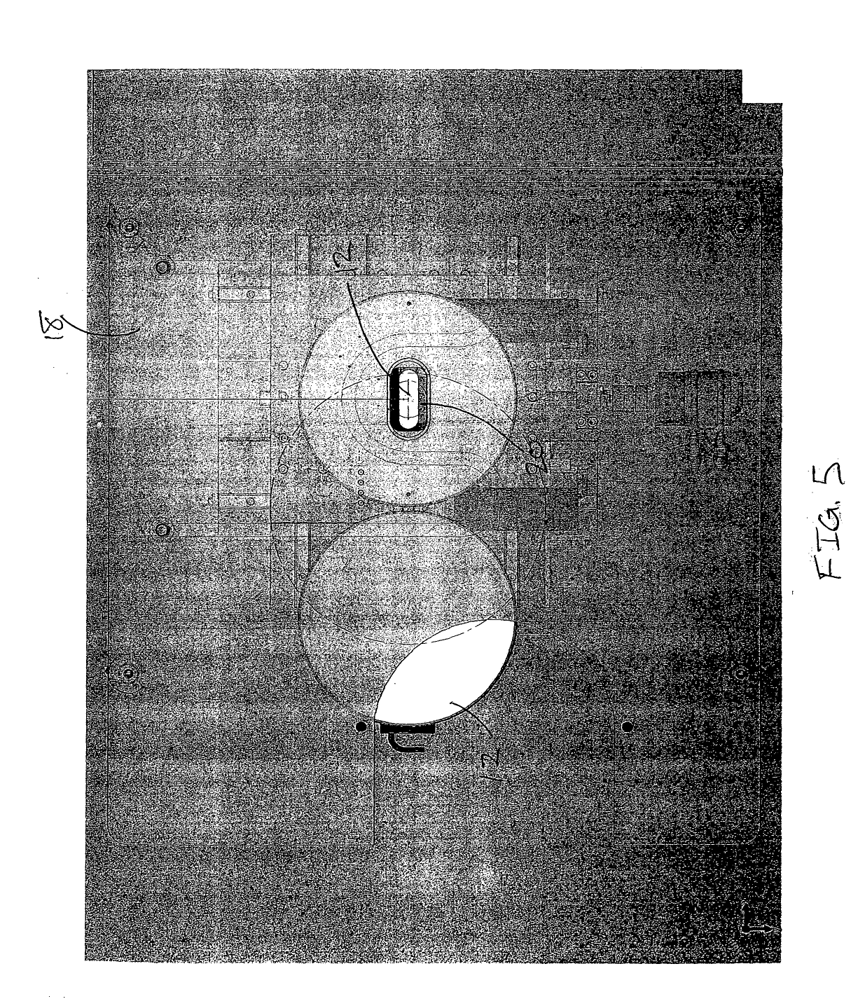

The target manipulation apparatus without the protective plate and other adjoining structure is illustrated in FIG. 6. The two targets 12 can each be formed of a different material so as to enable sequential coating of the different materials by switching the two targets from under the laser. The targets 12 can be formed of any solid, laser-ablatable material that may be desired for use as a coating. The manipulator can include only one target or multiple targets depending on application and need. Multiple targets of the same material can also be employed for extremely long depositions, such as those used in coated conductor applications (e.g., for tapes that are 100 m to 1 km long). In one example, the target is formed of an yttrium-barium-copper-oxide high-temperature superconductor, which can be deposited as a coating on a substrate formed, e.g., of LaAlO₃.

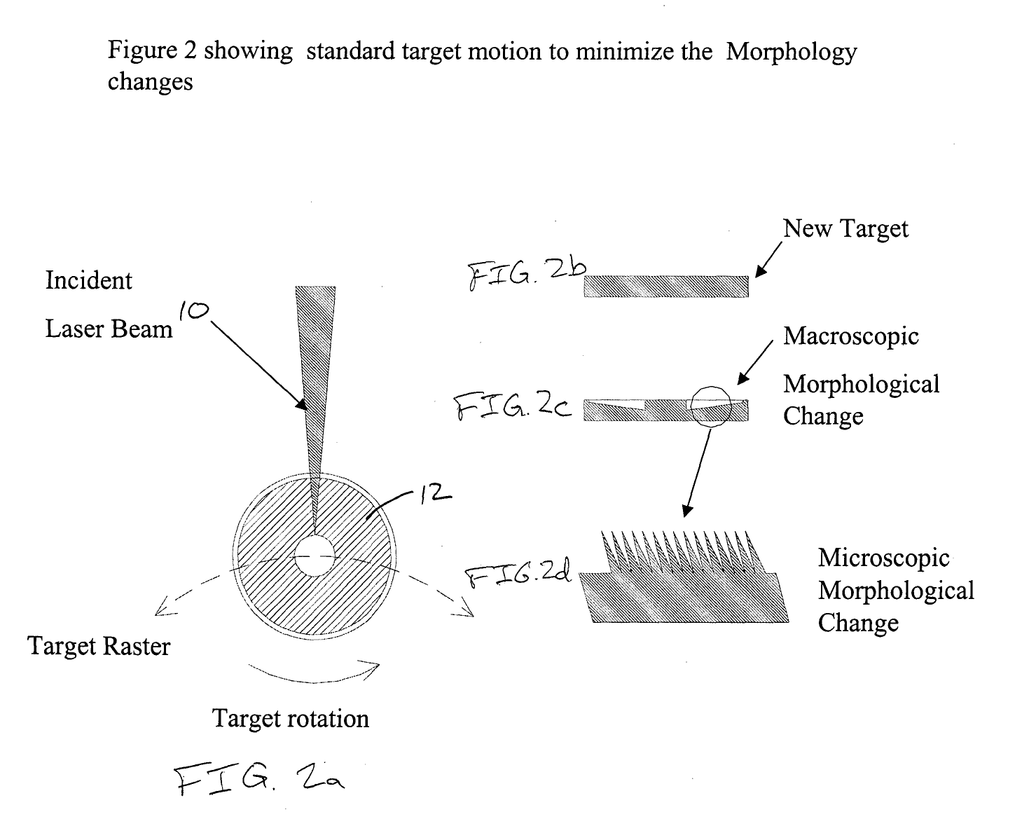

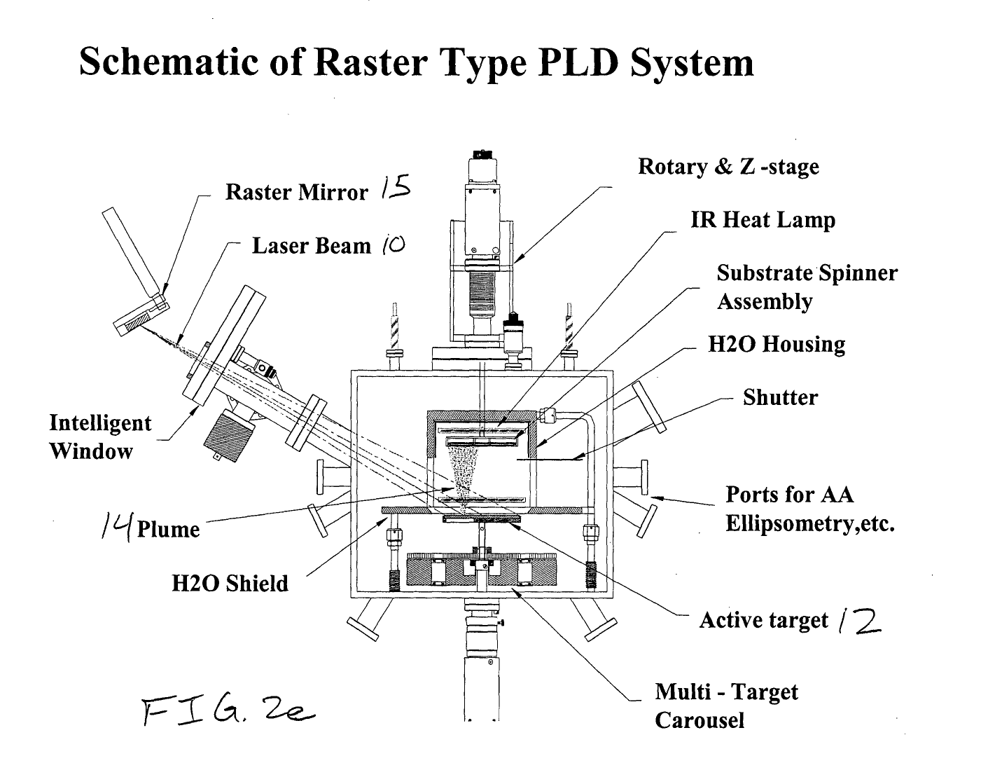

Each target is mounted on a rotatable platform 22, wherein the platforms 22 are coupled with a gear assembly for rotation. The two platforms 22 are mounted on opposite ends of a stage 26, which is rotatable about a center axis. The rotatable stage 26, in turn, is mounted on an x/y-displacement table comprising a displaceable structure 28 on a bottom support 30 that enable displacement of the stage along x- and y-axes. Accordingly, a target 12 can be rotated by rotating the platform; and the target 12 can be separately displaced along x- and y-axes by sliding the top structure 28 along the rails 32, 34 mounted on the bottom support 30. The x/y displacement table is available from THK Co., Ltd., of Tokyo, Japan. As an alternative or compliment to the x/y displacement of the target, the laser beam can be displaced with the raster mirror 15 when using the PLD system of FIG. 2e to perform these methods.

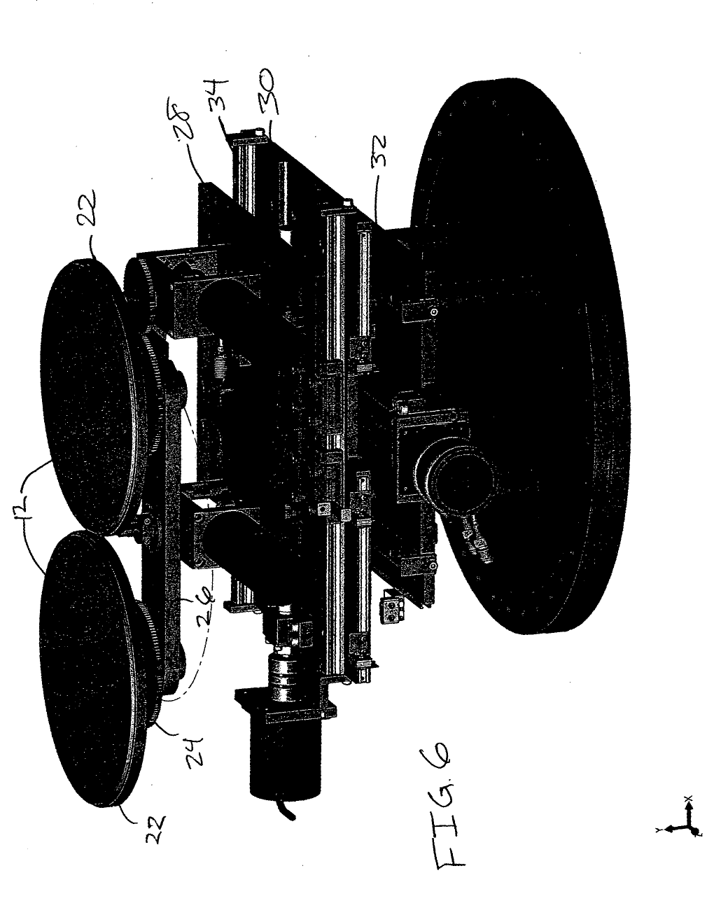

The laser in one embodiment of the first stage of the two-stage laser scanning procedure tracks a path 40 on the surface of the target 12, as shown in FIG. 7. The path 40 across the target 12 can be generated by moving the target and/or by moving the pulsed laser beam. In one embodiment, the laser's angle of incidence with the target is 60°. The laser can be, e.g., an excimer laser operating with KrF and having a wavelength of 248 nm or operating with ArF and having a wavelength of 193 nm. The pulse of the laser can be about 15 to 30 ns in duration. Other types of laser can be used, as well.

After completing the first (x/y) scan path, the target is rotated by a fixed angle, θ. In one embodiment, the target is rotated by 26.6° with each incremental rotation. The precise angle of incremental rotation can be varied, though division of a full rotation (i.e., 360°) by the angle of incremental rotation should not produce an integral. I.e., it is generally preferable to not end up at the same initial starting point after a limited number of rotations. Any combination of an x/y scan path and angle of incremental rotation that produces a fairly even distribution of the scan path lines across the full surface of the target is particularly suitable for these methods.

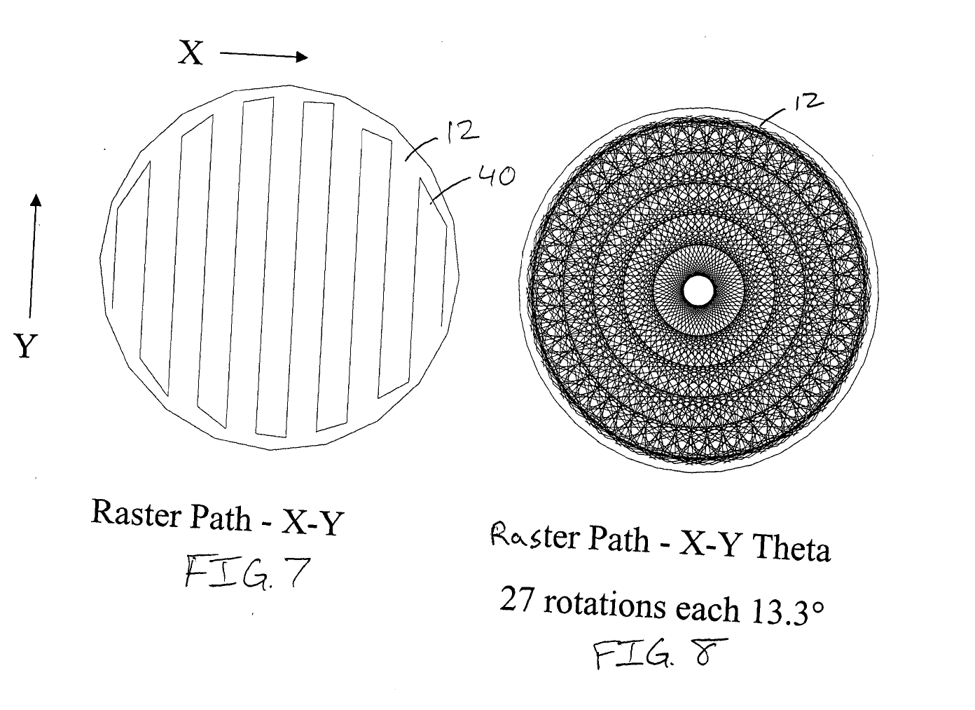

The complete scan path of 27 sequences of the x/y scan path of FIG. 7, each followed by a target rotation of 13.3°, is illustrated in FIG. 8. In this embodiment of the method, the rotation is performed after each x/y pattern is completed, though the rotation can alternatively be performed at another position during the x/y scan (i.e., at an interior x/y position on the path rather than at one of the path endpoints illustrated in FIG. 7). In either case, however, most or all of the x/y scan pattern will be carried out between incremental rotations (i.e., when the target is not rotating).

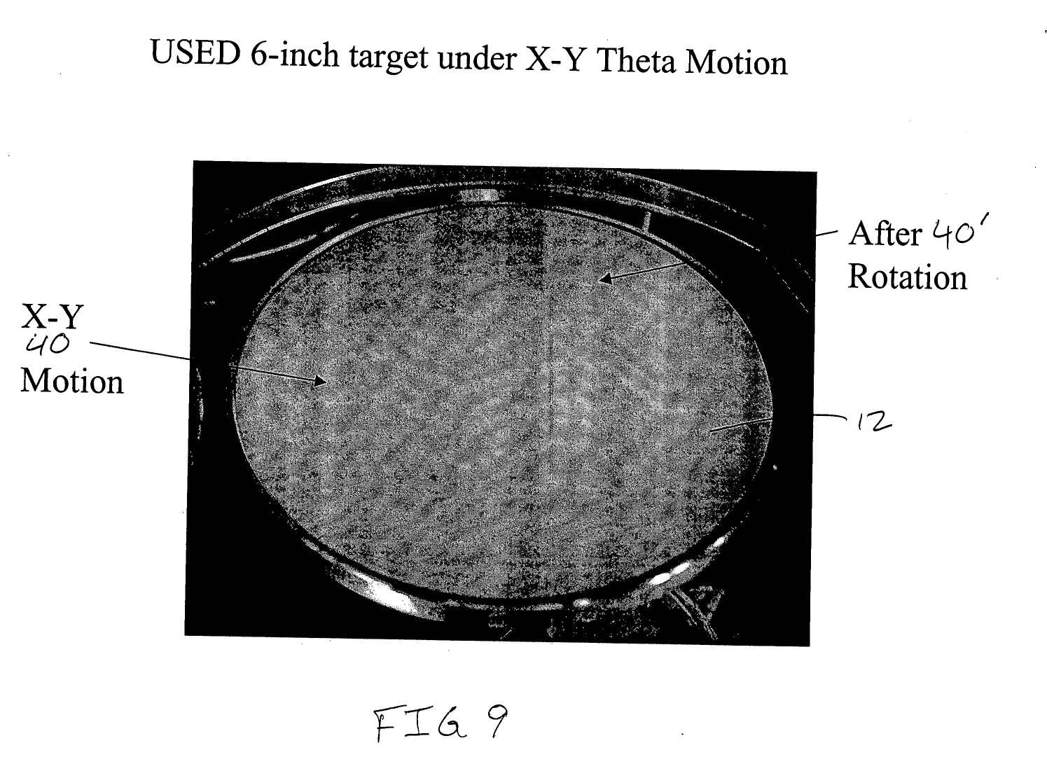

Finally, the surface of a 6-inch diameter target 12 that has been subjected to a complete x/y laser scan pattern 40; rotated 26.6°; and then to another, in this case partial, x/y laser scan pattern 40′ is illustrated in FIG. 9. The eroded path on the surface, which matches the laser scan path, appears in lighter relief on the target surface. As seen in FIG. 9, the spacing between the center of each linear pass in the x/y scan pattern in about twice the laser beam width.

The above-described methods can be carried out under instructions stored as software code on a computer-readable medium. The computer-readable medium is couple with a microprocessor, which in turn is coupled with a rotary motor for rotating the target platform and with motors in the x/y displacement table for providing axial displacement of the target. The x/y scan pattern is entered into the software via, e.g., a keyboard on a computer terminal. The software generates commands for x- and y-axis displacement of the target based on the entered scan pattern. An incremental angle of rotation, θ, and a number of rotation sequences to be performed are also entered into the software via the computer terminal. The software code provides instructions, to be executed by the microprocessor, for first generating the x/y displacement to execute the scan pattern. The software code then provides instructions for rotating the target by the angle, θ. The software then repeats the x/y displacement and rotation steps for the desired number of sequences.

Additional details regarding suitable pulsed-laser deposition apparatus and procedures for using the apparatus to produce coatings on a substrate are provided in the following U.S. patents, each of which is incorporated herein by reference in its entirety: U.S. Pat. No. 5,654,975; U.S. Pat. No. 5,942,040; and U.S. Pat. No. 6,024,851.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Moreover, while this invention has been shown and described with references to particular embodiments thereof, those skilled in the art will understand that various other changes in form and details may be made therein without departing from the scope of the invention.

1. A method for manipulating placement of pulsed laser across a target to ablate the target and deposit target material on a substrate, the method comprising:
a) providing a laser, a rotatable platform, and a substrate;
b) placing a target on the rotatable platform;
c) scanning a pulsed laser beam from the laser across the target in an x/y scan pattern with the rotational position of the target fixed to generate plumes of target material that are deposited on the substrate;
d) rotating the target by an incremental angle; and
e) repeating steps (c) and (d) in alternating sequence a plurality of times.

2. The method of claim 1, wherein the incremental rotations of the target occur only after a complete or substantially complete scan of the pulsed laser beam across the target.

3. The method of claim 1, wherein the x/y scan pattern is executed by displacing the target via an x/y displacement table upon which the target is mounted.

4. The method of claim 1, wherein the incremental angle of rotation is a non-integral divisor of 360°.

5. The method of claim 4, wherein the incremental angle of rotation is about 26.6°.

6. The method of claim 1, wherein the x/y scan pattern comprises a plurality of substantially parallel, linear passes across the target.

7. An apparatus for pulsed-laser deposition comprising:
a laser;
a rotatable platform upon which a target can be mounted;
a motor couple with the platform to rotate the platform by an incremental angle of rotation;
an x/y displacement table upon which the rotatable platform is mounted;
one or more motors coupled with the x/y displacement table to displace the rotatable platform along x- and y-axes.

8. An apparatus for pulsed-laser deposition comprising:
a laser that can generate a pulsed laser beam;
a rotatable platform upon which a target can be mounted;
a motor couple with the platform to rotate the platform by an incremental angle of rotation;
means for displacing the rotatable platform and/or the pulsed laser beam to generate an x/y scan pattern of the laser pulses across the surface of the target; and
a computer-readable medium storing software code that generates sequential commands for:
a) the motor coupled with the platform to rotate the platform by an angular increment and stop; and
b) the means for displacing the rotatable platform and/or the pulsed laser beam to execute the x/y scan pattern while the rotation of the platform is stopped.
